(19) United States
(12) Patent Application Publication
(10) Pub. No.: US 2005/0263980 A1
(43) Pub. Date: Dec. 1, 2005

(54) Zero-degree-offset bicycle stem

(76) Inventor: Aleksandr Alekseevich Bakhtin, Denver, CO (US)

Correspondence Address: Aleks A. Bakhtin, 9171 Flower Ct., Westminster, CO, 80021, US

(21) Appl. No.: 10/852,011

(22) Filed: May 25, 2004

(51) Int. Cl. B62K 1/00

(52) U.S. Cl. 280/279

(57) ABSTRACT

A bicycle handlebar stem specifically characterized, and distinct from other such stems in making it possible to attach the clamping surface of the handlebar in the center of the rotational axis of the steer tube. This stem, in union with a zero-degree-offset fork (already manufactured and popularly used) creates a front wheel/fork/stem/handlebar assembly; which is symmetrical in every respect. Such a symmetrical assembly being particularly dsirable in performing certain functions or tricks on stunt bicycles.

### CROSS-REFERENCE TO RELATED APPLICATIONS

This invention is most closely related to Mr. Kao's invention U.S. Pat. No. 5,678,458 Oct. 21, 1997. Especially in relation to the sport of flatland bicycling, the present invention claims the benefit of Mr. Kao's stem, as well as any other modern day stem.

### STATEMENT REGARDING FED SPONSORED R & D

Not Applicable.

### REFFERENCE TO SEQUENCE LISTING, A TABLE, OR A COMPUTER PROGRAM LISTING APPENDIX

Not Applicable.

### BACKGROUND OF THE INVENTION

This invention relates to bicycles, specifically to an improved way of attaching the handlebars to the steer-tube of a bicycle.

### DESCRIPTION OF PRIOR ART

A class of bicycle riding known as BMX (bicycle motor cross) is generally divided into four categories: racing, dirt, street, and flatland. This invention pertains mostly to flatland riding and an improvement in building a flatland bicycle. Flatland differs from other BMX categories mainly in that no jumps or obstacles are used. In flatland the rider performs a number of stunts such as changing direction while rolling on one wheel, flipping the bike around, flipping the handlebars around and so on while riding on flat pavement. Ending the trick by getting back on the bike and rolling away on both wheels without ever touching the ground with his feet.

A flatland bicycle differs from other BMX bicycles mainly in the use of a smaller, shorter frame for easier maneuvering while rolling of one wheel. And a shorter stem is used, so that when the handlebars are rotated 180 degrees from their original position they remain as close as possible to that original position in relation to the pedals, the seat and the rest of the bicycle. This is done so that when the rider flips the handlebars around 180 degrees, in order to keep balanced, he does not have to adjust as much with his body weight to compensate for the changed distance between the handlebars and the rest of the bicycle.

A specific way of routing the brake cables is employed when building a flatland bicycle. This is done in such a way that the brake cables, attached to the brake levers on the handlebars and routed to the brakes on the fork or frame of the bicycle, do not get tangled when the handlebars are rotated around their axis numerous times, as is frequently done as part of certain tricks.

The problem for Flatland riders has been that while manufacturers have made very short stems, they have not been able to make a stem that features a way for the handlebars to be attached in the center of the axis on which the steer-tube of the bicycle rotates. The problem for manufacturers has been that a stem is comprised of a vertical clamp (securing the stem to the steer-tube and keeping the steering bearings in place), and a horizontal clamp (securing the handlebars to the stem, and thus to the bicycle). Manufacturers have made stems to have a front end, featuring a horizontal clamp and a rear end, featuring a vertical clamp. As a result of this when the handlebars are attached they are off center in relation to the rotational axis of the steer-tube. A new design is needed to fix this problem.

### BRIEF SUMMARY OF THE INVENTION

The present invention solves the problem of the handlebars being attached off center of the rotational axis of the steer-tube. The way the present invention tackles this problem is by featuring the horizontal clamp, for clamping down the handlebars, directly on top of the vertical clamp, which is used to clamp the steer-tube. This places the handlebars directly in the center of the rotational axis of the steer-tube. Now, when, as part of a trick, a rider rotates the handlebars 180 degrees, the handlebars are still in the same position in relation to the rest of the bicycle.

### BRIEF DESCRIPTION OF THE SEVERAL VIEWS OF THE DRAWINGS

The drawings depict the several views of the components of the preferred embodiment of the invention.

FIG. 1 shows a top view of the cap of the stem.

FIG. 2 shows a side view of the cap of the stem.

FIG. 3 shows a side view of the cap of the stem, same as FIG. 2, only turned 90 degrees.

FIG. 4 shows a side view of the cap of the stem, same as FIG. 3, with the hidden lines shown, to assist in the understanding of the physical properties of the cap of the stem.

FIG. 5 shows a top view of the base of the stem.

FIG. 6 shows a side view of the base of the stem.

FIG. 7 shows a side view of the base of the stem, same as FIG. 6, only turned 90 degrees.

FIG. 8 shows a side view of the base of the stem, same as FIG. 7, with the hidden lines shown, to assist in the understanding of the physical properties of the base of the stem.

FIG. 9 shows an exploded view of the stem, including all the components of the stem, as well as the top portion of the steer tube and the bolts, to assist in the understanding of the assembly of the stem.

FIG. 10 shows a complete, assembled view of the stem, as well as the handlebars, the frame of the bicycle, the front fork of the bicycle, and the brake-cable-housing, in order to assist in the understanding of the assembly of the stem.

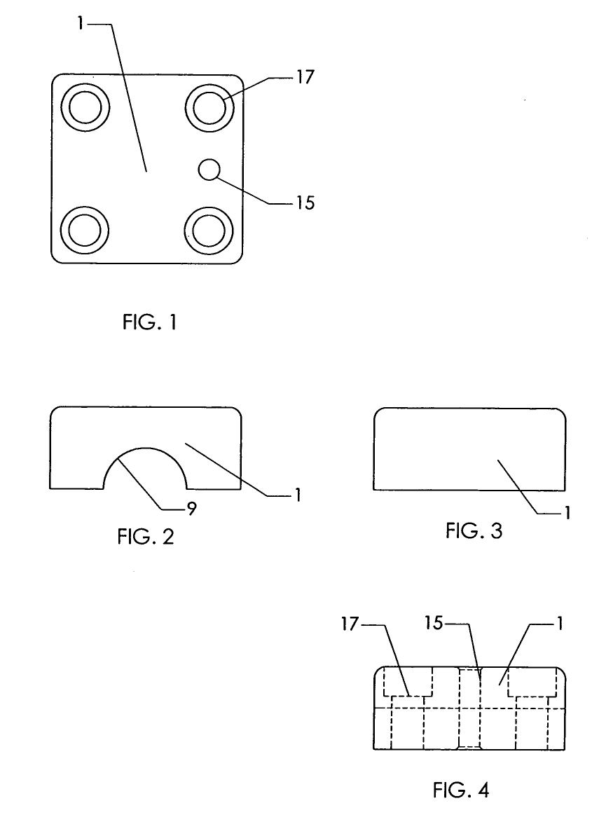

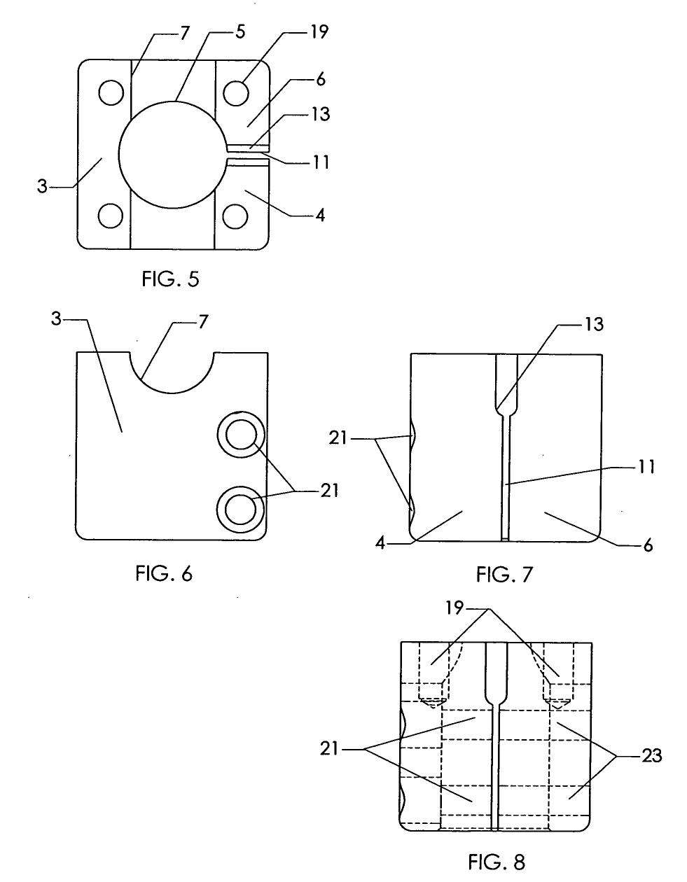

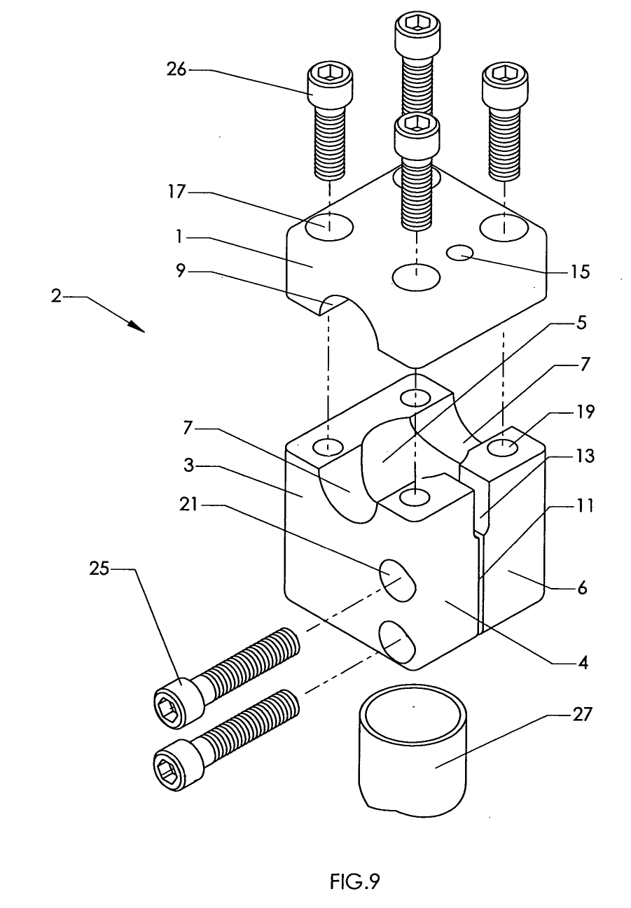

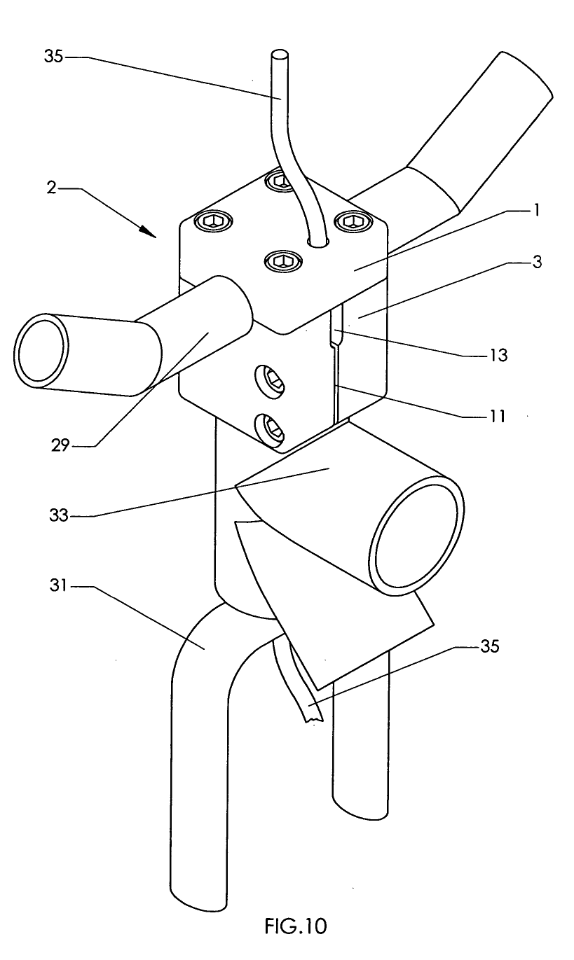

### DETAILED DESCRIPTION OF INVENTION

The preferred embodiment of this invention has two main components: a base 3, which features a steer-tube clamp and part of the clamping surface for the handlebar clamp, and a cap 1 that completes the handlebar clamp. Both of these components are used to separately fasten the stem 2 vertically, and the handlebar 29 horizontally.

The base 3 of the stem is in the form of a block. The main feature of the base 3 of the stem is a C-clamp, which is used to attach the stem 2 to the steer-tube 27. The base 3 features a through vertical inner cavity 5, in other words a hole, which defines the clamping surface of the steer tube clamp. There is, through one of the walls of the base 3, along the axis of the vertical inner cavity 5; a longitudinal slot 11. The wall 4 of the base 3, on one side of the longitudinal slot 11 has, at a 90 degree angle to the longitudinal slot 11, a number of horizontal through holes 21, for passing through them; bolts A. 25. The wall 6 of the base 3 on the opposite side of the longitudinal slot 11 has, at a 90 degree angle to the slot 11, a number of matching horizontal threaded holes 23 as means of accepting bolts A. 25. Upon tightening of bolts A. 25 the two sides of the wall, 4 and 6, are pulled towards each other. The longitudinal slot 11 provides means for the two sides of the wall, 4 and 6, of the C-clamp to compress relative to each other, thus changing the diameter of the through vertical inner cavity 5.

Toward the top of the base 3 of the stem, there is a widened section of the longitudinal slot 13, made to be sufficiently wide for the brake-cable-housing 35 to be passed through it, and then down through the steer-tube 27.

On the top surface of the base 3 of the stem, at a 90 degree angle to the longitudinal slot 11, and at the same angle to the vertical inner cavity 5, there is a horizontal semi cylindrical groove 7 for accepting the handlebar 29. Because the horizontal semi cylindrical groove 7 passes at a 90 degree angle directly through the vertical inner cavity 5; only the two opposing walls, 4 and 6, of the C-clamp bear the semi cylindrical groove 7. The center axis of the horizontal semi cylindrical groove 7 is coincident to the center axis of the vertical inner cavity 5 in the base 3 of the stem. In other words, there is no offset between the horizontal handlebar clamp and the vertical steer-tube clamp. Due to the fact that, when assembled, the vertical steer tube clamp clamps the steer tube 27 and the horizontal handlebar clamp clamps the handlebar 29; there is no offset between the rotational axis of the steer-tube 27 and the handlebar 29.

On the top surface of the base 3 of the stem there is on every corner of the base 3; a vertical threaded hole 19. The function of the vertical threaded holes 19 is to accept bolts B. 26 that attach the cap 1 of the stem to the base 3, and thus secure the handlebar 29 in place.

The cap 1 of the stem has, through its corners, a number of vertical through holes 17, matching the vertical threaded holes 19 in the corners of the base 3. Bolts B. 26 are passed through the vertical through holes 17 in the cap 1 of the stem, and into the vertical threaded holes 19 in the base 3. The bottom surface of the cap 1 has a horizontal semi cylindrical groove 9 matching the horizontal semi cylindrical groove 7 on the top surface of the stem base 3. When bolts B. 26, attaching the top cap 1 to the base 3 of the stem, are tightened, the distance between the cap 1 and the base 3 is decreased, thus sandwiching the handlebar 29 between the two semi cylindrical grooves, 7 and 9, and securing it in place. Due to the fact that the distance between the vertical threaded holes 19 in the base 3 of the stem changes when the steer-tube clamp is tightened or loosened; at least one of the vertical through holes 17 in the cap 1 is in the form of a slot. This gives bolts B. 26, attaching the cap 1 to the base 3, sufficient space to move about, perpendicular to their axes, when the steer-tube clamp is tightened or loosened.

The cap 1 features a vertical hole for passing through it, brake-cable-housing 35. The brake-cable-housing hole 15 in the cap 1 is positioned in such a way as to align with the widened section of the longitudinal slot 13 in the base 3 of the stem when assembled. This allows the brake-cable-housing 35 to be passed from the brake lever on the handlebar 29 through the top portion of the stem 2 through the steer tube 27, and to the front brake which is attached to the front fork 31 of the bicycle.

It is realized that upon assembly and the tightening of bolts A. 25 the horizontal semi-cylindrical groove 7 will become distorted due to the resulting compression of wall 4 towards wall 6. However, this distortion will not be sufficient to, upon further assembly, cause the handlebar 29 to become misaligned.

While the foregoing describes and illustrates particular embodiments of the invention, it is to be understood that many modifications may be made without departing from the spirit of the invention. I intend the following claims to cover any such modifications as fall within the true spirit and scope of the invention.

1. A clamping device for securing a bicycle handlebar to a bicycle steer tube where:
A tube of said bicycle handlebar where said tube has a clamping surface;
Said tube of a bicycle handlebar having a center axis;
A steer tube of a bicycle where said steer tube has a clamping surface;
Said steer tube having a center axis;
A means for fastening said clamping device to said clamping surface of said steer tube;
A means for fastening said handlebar tube to said clamping device where said means for fastening said handlebar tube allows for detachment of said handlebar;
Said clamping device having a means for fastening said handlebar to said steer tube such that said axis of said steer tube and said axis of said handlebar tube are kept substantially perpendicular and substantially coincident.

2. A clamping device as in claim 1 comprising;
(a) a base having a through vertical inner cavity and means to change the inner diameter of said through vertical inner cavity, said base having on the top surface thereof, at a 90 degree angle to said through vertical inner cavity, a horizontal groove; and
(b) a cap having on the bottom surface thereof a horizontal groove which, upon assembly of said clamping device, in union with said horizontal groove in said base, forms a clamping surface to provide means for fastening said handlebar tube to said clamping device;
(c) Said clamping device having means for attaching said cap to said base.

3. A clamping device as in claim 1,wherein:
Said clamping device being separated into upper and lower regions by a horizontal slot that passes horizontally from one side of said clamping device to the approximate center of said clamping device;
Said clamping device features a means for its attachment to a substantially vertical steer tube on a bicycle;
Said means for attachment comprising of a through vertical inner cavity in said lower region of the device and means to change the inner diameter of said through vertical inner cavity;
Said horizontal slot defining a means to attach a substantially horizontal handlebar tube to said clamping device;
Said horizontal slot being of sufficient width to allow for said handlebar tube to pass through it, and to centrally position said handlebar tube in the approximate center of said clamping device;
Said horizontal slot being positioned in a way such that said center axis of said handlebar tube is coincident to said center axis of said steer tube when said handlebar tube is secured in said approximate center of said clamping device;
Said clamping device featuring a means to compress said upper region towards said lower region thus fastening said handlebar tube to said clamping device.

4. A clamping device as in claim 2 where said horizontal groove is semi cylindrical.

5. A clamping device as in claim 2 where said horizontal groove is semi hexagonal.

6. A clamping device as in claim 2(a) where said means for changing the inner diameter of said through vertical inner cavity is through the use of threaded fasteners.

7. A clamping device as in claim 2(c) where said method of attaching said cap to said base is through the use of threaded fasteners.

8. A clamping device as in claim 3 where said means for changing the inner diameter of said through vertical inner cavity is through the use of threaded fasteners.

9. A clamping device as in claim 3 where said means for compression of said upper region towards said lower region is through the use of threaded fasteners.
